(19) United States
(12) Patent Application Publication
(10) Pub. No.: US 2011/0209448 A1
(43) Pub. Date: Sep. 1, 2011

(54) OIL SEPARATOR BUILT-IN SCROLL-TYPE COMPRESSOR

(76) Inventors: Toshimi Watanabe, Gunma (JP); Tatsuki Nomura, Gunma (JP); Jiro Iisuka, Gunma (JP)

(21) Appl. No.: 13/126,944

(22) PCT Filed: Oct. 29, 2009
(86) PCT No.: PCT/JP2009/068946

§ 371 Date: Apr. 29, 2011

(30) Foreign Application Priority Data
Oct. 29, 2008 (JP) 2008-278754

(51) Int. Cl. B01D 45/12

(52) U.S. Cl. 55/431

(57) ABSTRACT

Disclosed is an oil separator built-in scroll-type compressor which is compact and lightweight but still maintains the required strength, and which exhibits an excellent oil separating performance. The oil separator built-in scroll-type compressor includes a separation chamber which is disposed adjacent to a discharge chamber, and which separates an oil-containing gas introduced thereinto into gas and oil by centrifugal separation, and from which the separated oil is dropped downward and the gas is extracted upward; and a communication hole between the discharge chamber and the separation chamber through which the oil-containing gas is introduced from the discharge chamber into the separation chamber. The oil separator is formed as a joint structure comprising a fixed scroll element forming member and a compressor casing, and a bottom plate of the fixed scroll element forming member is formed in such a way as to be thinner at the part where the separation chamber is formed than at the part where the discharge chamber is formed.

### TECHNICAL FIELD OF THE INVENTION

The present invention relates to an oil separator built-in scroll-type compressor, and specifically relates to an oil separator built-in scroll-type compressor which has a required strength and is designed to achieve simplification and downsizing of an oil separator mechanism, reduction of the number of parts, ease of assembling and high separation performance.

### BACKGROUND ART OF THE INVENTION

Patent document 1 discloses a conventional oil separator built-in scroll-type compressor, which incorporates an centrifugal oil separator in a scroll-type compressor which is installed in a refrigeration system for automotive air conditioning devices. In a conventional oil separator built-in scroll-type compressor, when gas including oil in discharge chamber 2 is introduced into oil separation chamber 17 through communication hole 18 and the gas whirls along an inner wall surface of oil separation chamber 17, centrifugal force is generated so as to separate the gas and the oil, as shown in FIG. 5 with an example of cross section structure of conventional oil separation chamber 17 of oil separator 22. In Patent document 1, oil separation chamber 17 is formed with a structure where fixed scroll member 5 and casing 6 are put together on mating face 11.

Patent document 2 discloses a scroll-type compressor having a fixed scroll with a side plate which is made thin except for the center so that the volume of a oil storing chamber is enlarged. The center of fixed scroll of such a scroll-type compressor is required to have more strength than the periphery because pressure of compressed fluid becomes the highest in the center thereof. Therefore a concave is formed around the center of the fixed scroll so that the oil separator performance is improved while keeping required strength.
Patent document 1: JP2008-82238-A

### DISCLOSURE OF THE INVENTION

### Problems to be Solved by the Invention

As to conventional oil separator built-in scroll-type compressor 21 having a structure as disclosed in Patent document 1, expansion of volume of the oil storing chamber for oil separated in oil separation chamber 17 is not enough to significantly improve the performance of oil separator 22. In addition, a scroll-type compressor for automotive air conditioning systems is getting required to be compact and lightweight recently. However, even a strength securement is an important problem from a viewpoint of safety.

Therefore, being focused on the above-described problems and recent demand by markets, an object of the present invention is to provide an oil separator built-in scroll-type compressor which has superior oil separation ability as well as required strength in spite of its small size and light weight.

### Means for Solving the Problems

To achieve the above-described object, an oil separator built-in scroll-type compressor according to the present invention is an oil separator built-in scroll-type compressor having:

a separation chamber is disposed adjacent to a discharge chamber and which separates an oil-containing gas introduced thereinto into gas and oil by centrifugal separation and from which separated oil is dropped downward and separated gas is extracted upward; and

a communication hole between the discharge chamber and the separation chamber,

characterized in that an oil separator is formed as a joint structure comprising a compressor casing and a fixed scroll element forming member, a bottom plate of which is formed such that a thickness at a portion for forming the separation chamber is smaller than that at a portion for forming the discharge chamber.

The oil separator built-in scroll-type compressor according to the present invention can have an enlarged separation chamber without extension of an external shape size as keeping required strength at a portion forming the discharge chamber which has to be especially strong, because the oil separator is formed as the joint structure of two members for composing a compressor, which is an oil separator built-in compressor separating an oil-containing gas introduced thereinto into gas and oil by centrifugal separation, and the bottom plate of the fixed scroll element forming member is formed such that the separation chamber is thinner than the portion forming the discharge chamber. As a result an oil separator built-in scroll-type compressor which is compact and light and which has sufficiently high strength and superior oil separation ability is realized.

More concretely, the oil separator built-in scroll-type compressor can be formed such that the oil separator has a lower hole which delivers the oil separated in the separation chamber into the oil storing chamber below the separation chamber. In such a case, a bottom plate of the fixed scroll element forming member is preferably formed such that a thickness at a portion for forming the oil storing chamber is smaller than that at the portion for forming the discharge chamber. The thickness of the fixed scroll element forming member at the portion for forming separation chamber and the oil storing chamber are smaller than the thickness at the discharge chamber forming portion which requires specifically high strength, so that the volume of the oil storing chamber is enlarged in addition to the volume of the separation chamber. The enlargement of the volume of the oil storing chamber can increase an oil storing capacity. The increase of the oil storing capacity can consequently contribute to increase a separation capacity. It is also possible that the bottom plate of the fixed scroll element forming member at the portion for forming the oil storing chamber is formed such that a thickness at anti-discharge chamber side is smaller than a thickness at the discharge chamber side. The thickness of the bottom plate of the fixed scroll element forming member is smaller at the anti-discharge chamber side, where required strength is relatively small in the portion for forming the oil storing chamber, than the discharge chamber side, so that the volume as a whole oil storing chamber is further enlarged. Consequently, further weight saving of the compressor and further improvement of oil separation ability of the oil separator can be realized as keeping high strength as a whole compressor.

The oil separator built-in scroll-type compressor according to the present invention can be provided with a gas passageway between the oil separator and a discharge port connected to outside of a compressor, and the gas passageway can be formed as a joint structure of the fixed scroll element forming member and a compressor casing between the fixed scroll element forming member and the compressor casing, and second discharge chamber is formed between the separation chamber and the discharge port. When such a structure is employed, the bottom plate of the fixed scroll element forming member is preferably formed such that a thickness at a portion for forming the second discharge chamber is smaller than the thickness at the portion for forming the discharge chamber. The second discharge chamber is located at a position short of the discharge port where the gas is delivered after separated from the oil in the separation chamber. Because its required strength is lower than the separation chamber and therefore the required strength is lower than the portion for forming the discharge chamber, the compressor as a whole has a sufficient strength if the bottom plate of the fixed scroll element forming member is formed such that the thickness at the portion for forming the second discharge chamber is smaller than that at the portion for forming the discharge chamber. Because the volume of the second discharge chamber is enlarged to reduce the pressure loss in the second discharge chamber and because the gas flow is prevented from pulsing with the second discharge chamber as a kind of buffer to the gas flow before being discharged from the discharge port, the compressor operational characteristics and the oil separator separation characteristics are stabilized and the compressor is made light.

In the oil separator built-in scroll-type compressor of the present invention, it is preferable that the bottom plate of the fixed scroll element forming member is formed such that a thickness at a portion for forming the communication hole is smaller than the thickness at the portion for forming the discharge chamber. Because required strength of the portion for forming the communication hole is lower than that of the portion for forming the discharge chamber, the compressor as a whole has a required strength even if the bottom plate of the fixed scroll element forming member is thinner at the portion for forming the communication hole. Because the pressure loss at the communication hole is reduced by enlargement of the volume of the communication hole and the gas flow is stabilized, the compressor operational characteristics and the oil separator separation characteristics are stabilized and the compressor is made light.

Further, in the oil separator built-in scroll-type compressor according to the present invention, it is possible that the bottom plate of the fixed scroll element forming member is formed such that a thickness at a portion to contact with a discharge valve controlling a compressed gas to be introduced into the discharge chamber is larger than a thickness at another portion in the discharge chamber. Because the gas pressure is high in the discharge chamber, the portion for forming the discharge chamber is required to have a relatively high strength. However in the discharge chamber, the peripheral side of the discharge valve is required to have a relatively low strength than the neighborhood thereof. From a viewpoint of further saving weight of the portion for forming the discharge chamber, it is preferable that the bottom plate of the fixed scroll element forming member is formed such that the thickness of the bottom plate at the portion to contact with the discharge valve in the portion to form the discharge chamber is larger than the thickness at the other portion to form the discharge chamber.

In the present invention, it is possible that the separation chamber is formed such that a cross-sectional shape is an oval shape and a major axis of the oval shape is disposed in a direction perpendicular to the mating face of the joint structure. Because an oil separator built-in scroll-type compressor, such as of the present invention, which is provided with the oil separator formed with a joint structure of two members consists of small number of component parts without a portion to be machined, the shape of the separation chamber can be extremely freely formed. Therefore, the separation chamber can be formed into a cylindrical shape of which bus part extends linearly, and alternatively into a cylindrical shape, such as a donut shape as a whole (a partial donut shape), of which bus part curves. Besides, if the bottom plate of the fixed scroll element forming member is made thinner from the cylindrical shape along a basic technical idea of the present invention, the cross-sectional shape can be an oval shape and a major axis of the oval shape can be disposed in a direction perpendicular to a mating face of the joint structure. The separation chamber can be made to have a structure with such an oval cross section so as to achieve an oil separator built-in scroll-type compressor which has lighter weight, sufficient strength and superior oil separation ability.

In the oil separator built-in scroll-type compressor according to the present invention, it is possible that the communication holes are disposed along a vertical direction, so as to improve the oil separation efficiency. For example, the communication holes can be formed with a structure where the communication holes are opened in a same direction toward the separation chamber. In such a case, even if the amount of gas blown into the oil separation chamber is relatively large, each direction for blowing of gas through each communication holes can be optimized, so that centrifugal separation is performed efficiently in the separation chamber and efficiently introduces separated oil into the oil storage chamber. Alternatively, if the communication holes are opened in different directions toward the separation chamber, each direction of gas blowing into the oil separation chamber can be set at a different angle according to each communication hole. Therefore the gas blowing direction can be set as suitable to the shape of the oil separation chamber, so that the gas blown from each communication hole is efficiently separated centrifugally to introduce the efficiently separated oil into the oil storing chamber.

Such an oil separator built-in structure in the present invention is applicable to substantively all scroll-types of compressors, and is suitable for a compressor in an automotive air conditioning system, because the oil separator is formed with a joint structure of two members for composing the compressor and therefore is easy to simplify its structure and to reduce its size and weight.

### Effect According to the Invention

Thus, the oil separator built-in scroll-type compressor according to the present invention can have an enlarged separation chamber without extension of an external shape size as keeping required strength at a portion forming the discharge chamber which has to be especially strong, because the oil separator is formed as the joint structure of two members for composing the compressor and because the bottom plate of the fixed scroll element forming member is formed such that the portion forming the oil storing chamber is thinner than the portion forming the discharge chamber. Such a separation chamber with the enlarged volume makes it possible to reduce the pressure loss in the separation chamber and to suppress the pulsation of gas flow. In addition, the compressor becomes lightweight by weight corresponding to the part of the fixed scroll element forming member where the volume of the separation chamber is enlarged. Thus the present invention makes it possible to achieve downsizing and weight saving, as well as improvement of oil separation performance, while securing predetermined strength. In addition, the oil separator built-in scroll-type compressor of the present invention is suitably used as a compressor for automotive air conditioning system, because of its joint structure suitable for downsizing and weight saving.

### BRIEF EXPLANATION OF THE DRAWINGS

FIG. 1 is a longitudinal sectional view showing a joint structure of an oil separator built-in compressor according to an embodiment of the present invention.

FIG. 2 is a cross-sectional view showing a cross section of the compressor shown in FIG. 1, where (a) is a cross section viewed along A-A direction in FIG. 1 and (b) is a cross section viewed along B-B direction in FIG. 1.

FIG. 3 is a cross-sectional view of a separation chamber composing an oil separator shown in FIG. 2.

FIG. 4 shows a fixed scroll element forming member according to another embodiment of the present invention, where (a) is an elevational view, (b) is a COD sectional view of (a), and (c) is a COD sectional view of a fixed scroll element forming member shown in FIG. 2, corresponding to (b).

FIG. 5 is a cross-sectional view of a separation chamber of a conventional oil separator built-in compressor.

### EXPLANATION OF SYMBOLS

1, 21: oil separator built-in compressor
2: discharge chamber
3: second discharge chamber
4: oil storing chamber
5: fixed scroll element forming member
6: casing
7, 17: separation chamber
8, 18: communication hole
8a: upper communication hole
8b: lower communication hole
9: lower hole
10: gas passageway
11: mating position
12, 22: oil separator
13: discharge valve
14: discharge hole

### THE BEST MODE FOR CARRYING OUT THE INVENTION

Hereinafter, desirable embodiments of the present invention will be explained as referring to figures.

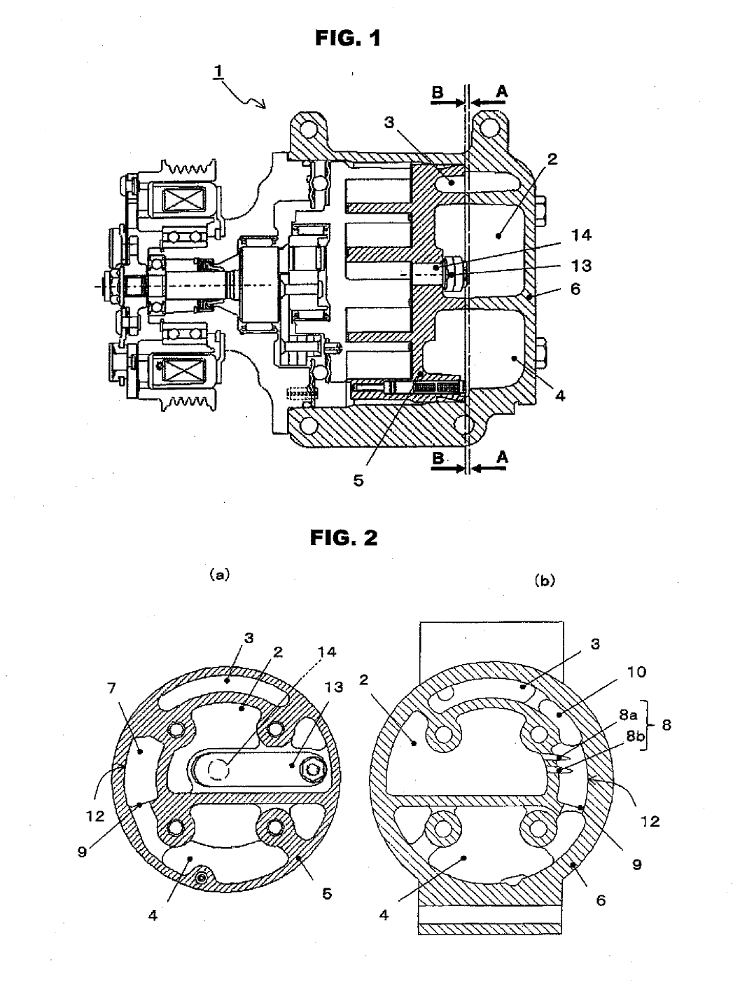

FIG. 1 is a longitudinal sectional view showing a joint structure of an oil separator builit-in compressor according to an embodiment of the present invention. In compressor 1, discharge chamber 2, second discharge chamber 3 and oil storing chamber 4 are formed with a joint structure of fixed scroll element forming member 5 and casing 6. A bottom plate of fixed scroll element forming member 5 has a portion which contacts with discharge valve 13 regulating the introduction of compressed gas into discharge chamber 2 by controlling opening and shutting discharge hole 14. The portion is thicker than the other portion in discharge chamber 2, therefore the axial directional depth of discharge chamber 2 is smaller at the portion which contacts with discharge valve 13. Further, the bottom plate of fixed scroll element forming member 5 is thinner at anti-discharge chamber side (lower side of Fig.) of oil storing chamber 4 than at discharge chamber side (upper side of the Fig.). Therefore the axial directional depth is larger at the anti-discharge chamber side than at the discharge chamber side.

FIG. 2 is a cross-sectional view showing a cross section of the compressor shown in FIG. 1, where (a) is a cross section viewed along A-A direction in FIG. 1 and (b) is a cross section viewed along B-B direction in FIG. 1. As shown in FIG. 2 (b), casing 6 is shaped to form communication hole 8 and is combined with fixed scroll element forming member 5 shown in FIG. 2 (a), so as to form lower communication hole 8b and upper communication hole 8a communicating discharge chamber 2 and separation chamber 7. Fixed scroll element forming member 5 is formed such that the thickness of a portion to form separation chamber 7 is smaller than that of a portion to form discharge chamber 2. Additionally in this embodiment, the bottom plate thickness is larger at the portion contacting with discharge valve 13 in the portion to form discharge chamber 2 than at the other portion in the portion to form discharge chamber 2. Further, the bottom plate thickness of fixed scroll element forming member 5 in a portion to form oil storing chamber 4 is smaller at anti-discharge chamber side (lower side of Fig.) than at the discharge chamber side (upper side of Fig.). Furthermore, both of casing 6 and fixed scroll element forming member 5 are shaped to form lower hole 9 and combined with each other to form lower hole 9 communicating separation chamber 7 and oil storing chamber 4. Oil-containing compressed gas, which has been compressed with a scroll-type compression mechanism and introduced in discharge chamber 2, is delivered through communication hole 8 into separation chamber 7, so as to generate whirling flow along the inner wall of separation chamber 7. It is preferable that the whirling flow makes a whirling flow falling along the inner wall of separation chamber 7 and that oil contained in the gas is centrifugally separated from the gas, and the separated oil falls along the inner wall of separation chamber 7 to be stored through lower hole 9 into oil storing chamber 4. On the other hand, the gas separated from the oil is delivered into second discharge chamber 3 as generating upflow in the center of cross-section of separation chamber 7, and is discharged through a discharge port out of the system. Thus compressor 1 incorporates oil separator 12 comprising separation chamber 7, communication hole 8, lower hole 9 and oil storing chamber 4.

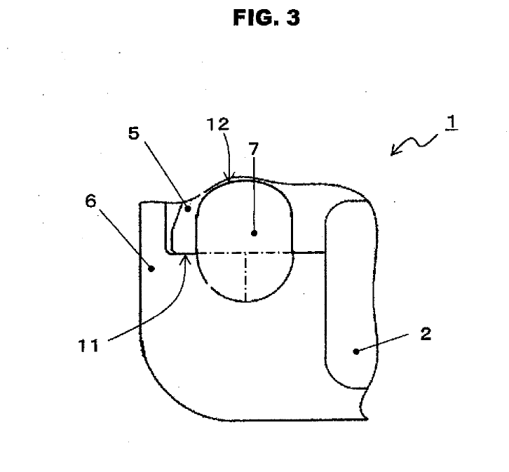

FIG. 3 is a cross-sectional view of a separation chamber composing an oil separator shown in FIG. 2. Separation chamber 7 has been formed such that its depth becomes larger from mating face 11 to fixed scroll element forming member 5 than that of separation chamber 17 having circular cross-section in conventional oil separator 22 shown in FIG. 5, and that separation chamber 7 has an oval cross-section of which major axis is perpendicular to mating face 11. In comparison with separation chamber 7 in FIG. 3 and separation chamber 17 in FIG. 5, separation chamber 7 has larger volume of separation chamber than separation chamber 17, in spite of the same external shape of walls forming oil separators 12, 22. Thus in this embodiment, cross-section of separation chamber 7 has been enlarged from a conventional structure, so as to improve the oil separation performance. In addition, the pressure loss in separation chamber 7 has been reduced and the gas flow is not likely to pulse. Besides, communication hole 8 is not depicted in FIG. 3 but FIG. 5 because it shows a cross-section cut by a flat surface which does not cross communication hole 8 in FIG. 2. Though separation chamber 7 is formed such that the depth becomes deeper from mating face 11 to fixed scroll element forming member 5 in this embodiment, separation chamber 7 can be formed such that the depth becomes deeper from mating face 11 to casing 6.

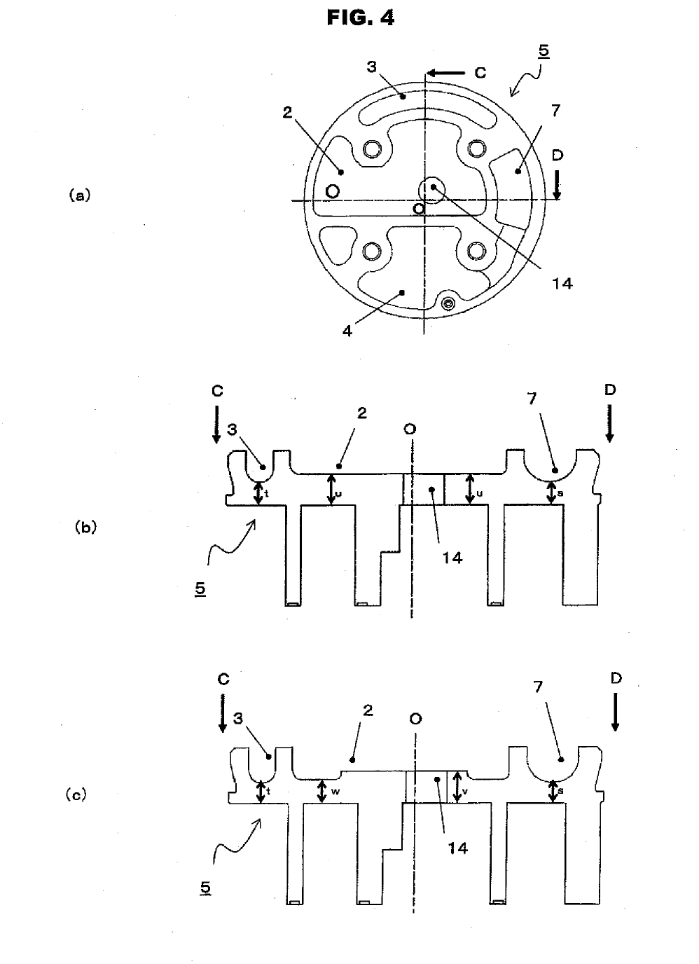

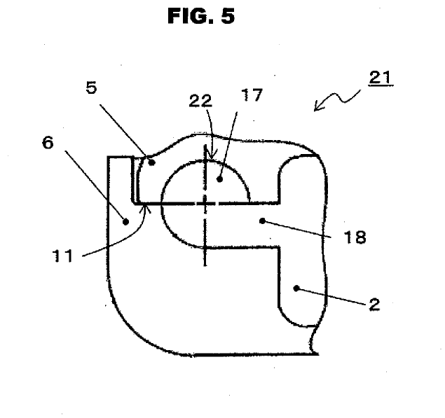

FIG. 4 shows a fixed scroll element forming member according to another embodiment of the present invention, where (a) is an elevational view, (b) is a COD sectional view of (a), and (c) is a COD sectional view of a fixed scroll element forming member shown in FIG. 2, corresponding to (b). In FIG. 4 (b), the thickness of the bottom plate of fixed scroll element forming member 5 has thickness (s) at a portion to form separation chamber 7 and thickness (t) at a portion to form second discharge chamber 3, which are smaller than thickness (u) at a portion to form discharge chamber 2. In FIG. 4 (c), like the explanation of FIG. 2, as to the thickness of a portion to form discharge chamber 2 in the bottom plate of fixed scroll element forming member 5, thickness (v) in a portion to contact discharge valve 13 around discharge hole 14 is larger than thickness (w) in the other portion. Thus the present invention provides an oil separator built-in scroll-type compressor which has superior oil separation performance as well as required strength in spite of its small size and light weight as a whole compressor, because the thickness of fixed scroll element forming member 5 in each portion is set according to required strength.

### INDUSTRIAL APPLICATIONS OF THE INVENTION

The structure of the oil separator built-in scroll-type compressor according to the present invention is applicable to any type of scroll-type compressor which incorporates an oil separator.

1. An oil separator built-in scroll-type compressor having comprising:
a separation chamber is disposed adjacent to a discharge chamber and which separates an oil-containing gas introduced thereinto into gas and oil by centrifugal separation and from which separated oil is dropped downward and separated gas is extracted upward; and
a communication hole between said discharge chamber and said separation chamber,
wherein an oil separator is formed as a joint structure comprising a compressor casing and a fixed scroll element forming member, a bottom plate of which is formed such that a thickness at a portion for forming said separation chamber is smaller than that at a portion for forming said discharge chamber.

2. The oil separator built-in scroll-type compressor according to claim 1, wherein said oil separator has a lower hole which delivers said oil separated in said separation chamber into said oil storing chamber below said separation chamber, and a bottom plate of said fixed scroll element forming member is formed such that a thickness at a portion for forming said oil storing chamber is smaller than that at said portion for forming said discharge chamber.

3. The oil separator built-in scroll-type compressor according to claim 2, wherein said bottom plate of said fixed scroll element forming member at said portion for forming said oil storing chamber is formed such that a thickness at anti-discharge chamber side is smaller than a thickness at said discharge chamber side.

4. The oil separator built-in scroll-type compressor according to claim 1, wherein a compressor is provided with a gas passageway between said oil separator and a discharge port connected to outside of a compressor, and said gas passageway is formed as a joint structure of said fixed scroll element forming member and a compressor casing between said fixed scroll element forming member and said compressor casing, and second discharge chamber is formed between said separation chamber and said discharge port, and said bottom plate of said fixed scroll element forming member is formed such that a thickness at a portion for forming said second discharge chamber is smaller than said thickness at said portion for forming said discharge chamber.

5. The oil separator built-in scroll-type compressor according to claim 1, wherein said bottom plate of said fixed scroll element forming member is formed such that a thickness at a portion for forming said communication hole is smaller than said thickness at said portion for forming said discharge chamber.

6. The oil separator built-in scroll-type compressor according to claim 1, wherein said bottom plate of said fixed scroll element forming member is formed such that a thickness at a portion to contact with a discharge valve controlling a compressed gas to be introduced into said discharge chamber is larger than a thickness at another portion in said discharge chamber.

7. The oil separator built-in scroll-type compressor according to claim 1, wherein said separation chamber is formed such that a cross-sectional shape is an oval shape and a major axis of said oval shape is disposed in a direction perpendicular to a mating face of said joint structure.

8. The oil separator built-in scroll-type compressor according to claim 1, wherein said communication holes are disposed along a vertical direction.

9. The oil separator built-in scroll-type compressor according to claim 8, wherein said communication holes are opened in a same direction toward said separation chamber.

10. The oil separator built-in scroll-type compressor according to claim 8, wherein said communication holes are opened in different directions toward said separation chamber.

11. The oil separator built-in scroll-type compressor according to claim 1, wherein a compressor is used in an automotive air conditioning system.
